(19) United States
(12) Patent Application Publication
(10) Pub. No.: US 2013/0326932 A1
(43) Pub. Date: Dec. 12, 2013

(54) Fishing Leader Line Holder

(71) Applicant: Jong Lee, Mill Creek, WA (US)

(72) Inventor: Jong Lee, Mill Creek, WA (US)

(21) Appl. No.: 13/490,248

(22) Filed: Jun. 6, 2012

(51) Int. Cl. A01K 97/06

(52) U.S. Cl. 43/57.2

(57) ABSTRACT

Disclosed is, among other things, a fishing leader line holder which may allow for safe and convenient storage of leader lines with hooks. The fishing leader line holder may include adjustable line wraps and hook-holders to accommodate fishing leader lines of different length.

### FIELD

This disclosure relates to fishing leader line holders.

### BACKGROUND

A fishing leader line is a length of fishing line which attaches to a hook and to a main fishing line. Leader lines are used for various purposes, one of which is reducing a line's visibility to fish. Differing strengths and types of lines may be desired for different situations, so it may be desirable to carry several leader lines on a fishing trip to allow substituting when appropriate.

Fishing leader lines with hooks attached may be challenging to carry. Hooks may easily cause problems by catching on items in a tackle box, for example, and loose leads may become tangled and hooks may end up in different positions than expected, which may even cause injuries.

### SUMMARY OF THE INVENTION

The instant application discloses, among other things, a fishing leader line holder which may allow for safe and convenient storage of fishing leader lines with hooks.

A series of pegs inserted on a backing panel may allow for placing a hook on one peg, and the wrapping of the lead line around as many other pegs as needed, which may allow for leads of varying lengths to be stored together. Several of the pegs may be movable, which may allow a loosening of the lead line after wrapping to prevent the lead line from becoming creased or damaged from being too tightly wrapped.

A slotted block may be used to store the end of the lead line opposite from the hook, with slots which may hold the lead line without allowing it to slip.

### BRIEF DESCRIPTION OF THE DRAWINGS

FIG. 1 is a drawing of one embodiment of a Fishing Leader Line Holder.

FIG. 2 is a drawing of another embodiment of a Fishing Leader Line Holder.

FIG. 3 is a drawing of another embodiment of a Fishing Leader Line Holder.

FIG. 4 illustrates one example of a fishing leader line.

FIG. 5 is a top view of one embodiment of a Sliding Line Wrap.

FIG. 6 is a front view of one embodiment of a Sliding Line Wrap.

FIG. 7 is a top view of another embodiment of a Sliding Line Wrap.

FIG. 8 is a top view of one embodiment of a Block Line Holder.

FIG. 9 is a front view of one embodiment of a Block Line Holder.

Like reference numerals indicate like elements in the drawings. Elements in the drawings are not drawn to scale unless otherwise indicated.

### DESCRIPTION OF THE INVENTION

A more particular description of certain embodiments of a Fishing Leader Line Holder may be had by references to the embodiments shown in the drawings which form a part of this specification, in which like numerals represent like objects.

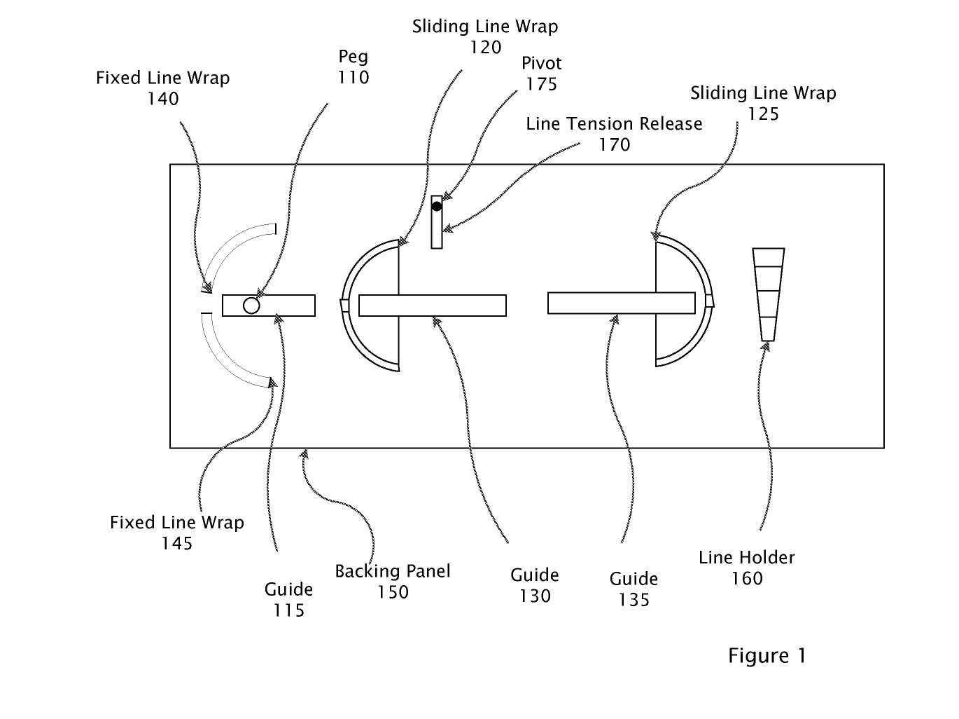

FIG. 1 is a drawing of one embodiment of a Fishing Leader Line Holder. In this embodiment, Backing Panel 150 may support numerous devices used for wrapping leader line. In this example, two Fixed Line Wraps 140, 145, two Sliding Line Wraps 120, 125, one Peg 110, one Block Line Holder 160, and one Line Tension Release 170 may be used.

Sliding Line Wrap 120 may have an extension through Backing Panel 150 to allow for it to slide for adjusting a position. For example, a leader line may have a hook placed on Peg 110, with fishing line wrapped around Sliding Line Wrap 125 and Sliding Line Wrap 120, with a loose end placed in Block Line Holder 160. Peg 110 may slide within Guide 115 to adjust for leader lines of varying lengths. A longer leader line may again have a hook placed on Peg 110, and have fishing line wrapped around Fixed Line Wrap 140, Fixed Line Wrap 145, Sliding Line Wrap 125 and Sliding Line Wrap 120, with a loose end placed in Block Line Holder 160. Leader lines of various lengths may be accommodated by choosing which line wraps to use. Once a leader line is wrapped, Line Tension Release 170 may be rotated around a Pivot 175 to loosen the leader line, which may reduce kinks from forming in the fishing line.

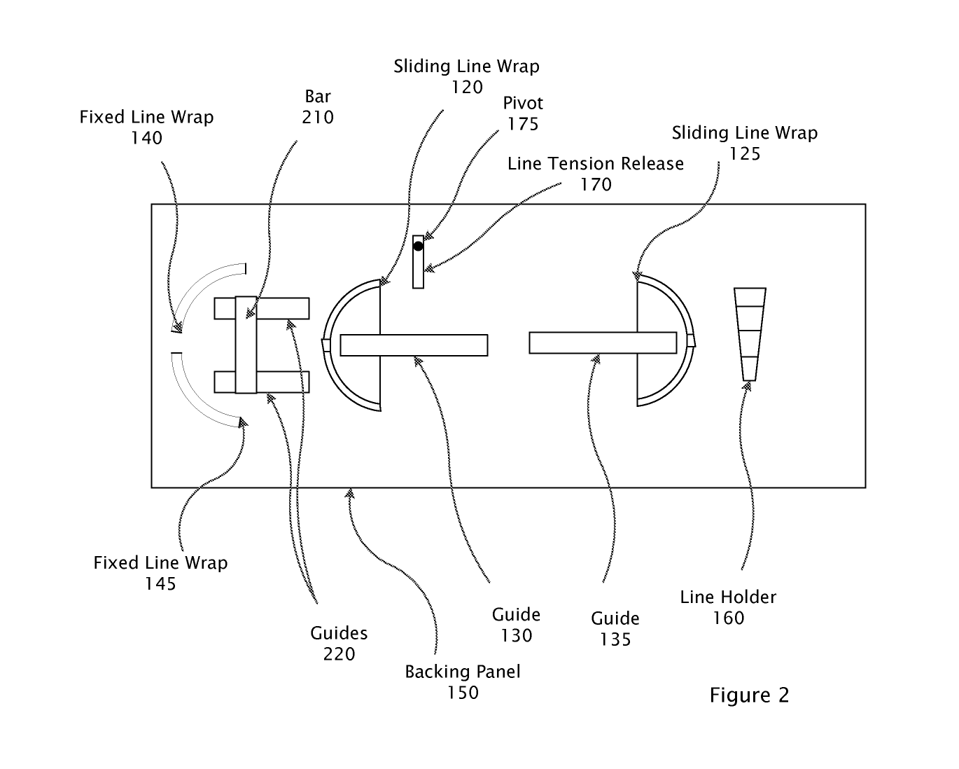

FIG. 2 is a drawing of another embodiment of a Fishing Leader Line Holder. Bar 210 may hold one or more hooks, and may move in Guides 220 to adjust for various lengths of leader lines.

In yet another embodiment, a Fishing Leader Line Holder may comprise both Peg 110 and Bar 210 with Guides 220.

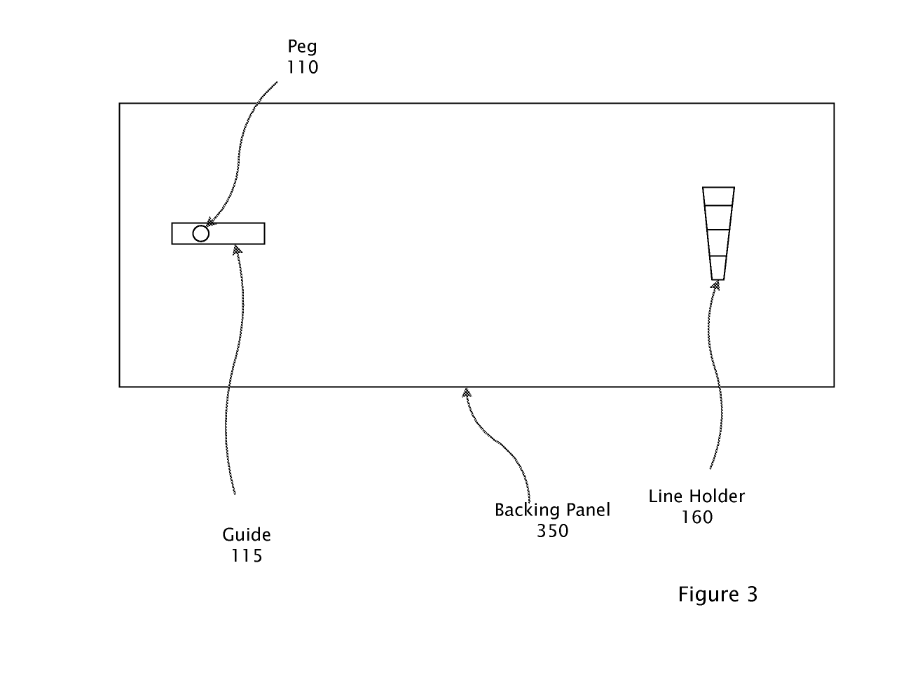

FIG. 3 is a top view of another embodiment of a Fishing Leader Line Holder. In this embodiment, Block Line Holder 160 may be fixed to Backing Panel 350, and may be used to secure a loose end of a Fishing Leader Line, while a hook may be placed on movable Peg 110, which may be adjustable along Guide 115. In one embodiment, Peg 110 may have a spring configured to Peg 110 toward a near end of Backing Panel 350, which may hold a Fishing Leader Line taut. In another embodiment, Peg 110 may be replaced by a spring which may directly hold a fishing leader line hook, keeping the line taut. In yet another embodiment, a peg may be used to hold a loose end, and in yet another embodiment, a loose end of a Fishing Leader Line may be inserted between coils of a spring. One skilled in the art will recognize that many different devices may be combined with a spring and used to hold a hook of a Fishing Leader Line to keep the line taut.

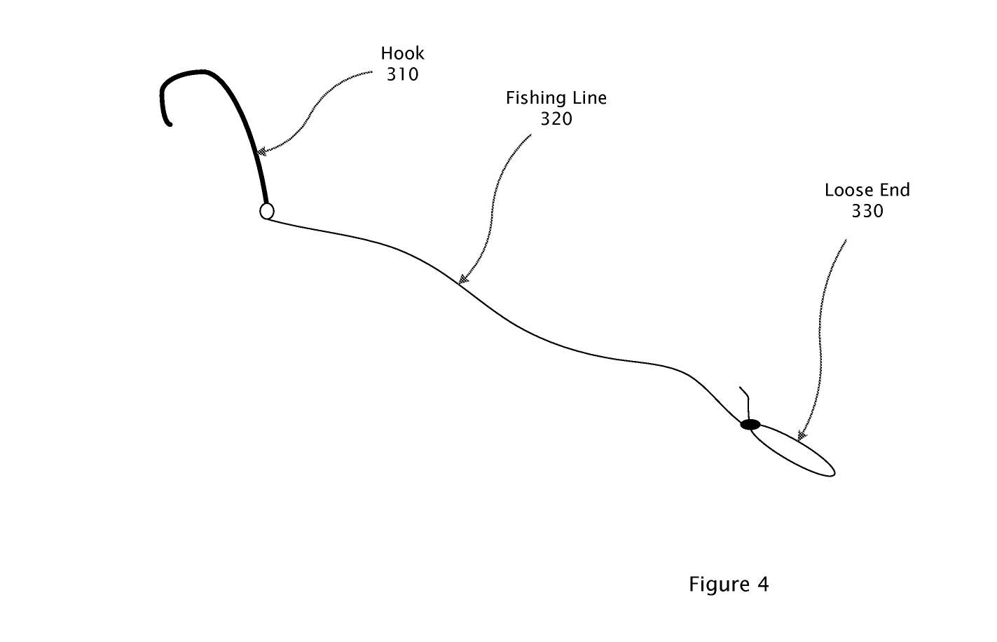

FIG. 4 illustrates one example of a fishing leader line. This fishing leader line is typical, with a fish Hook 310 on one end, and a loop tied on Loose End 330. Fishing Line 320 may be more transparent to fish than a main line being used. This fishing leader line may be held with a Fishing Leader Line Holder.

One having skill in the art will recognize that other fishing leader lines may be used with a Fishing Leader Line Holder, including, for example, a fishing leader line with a swivel or a weight on the loose end.

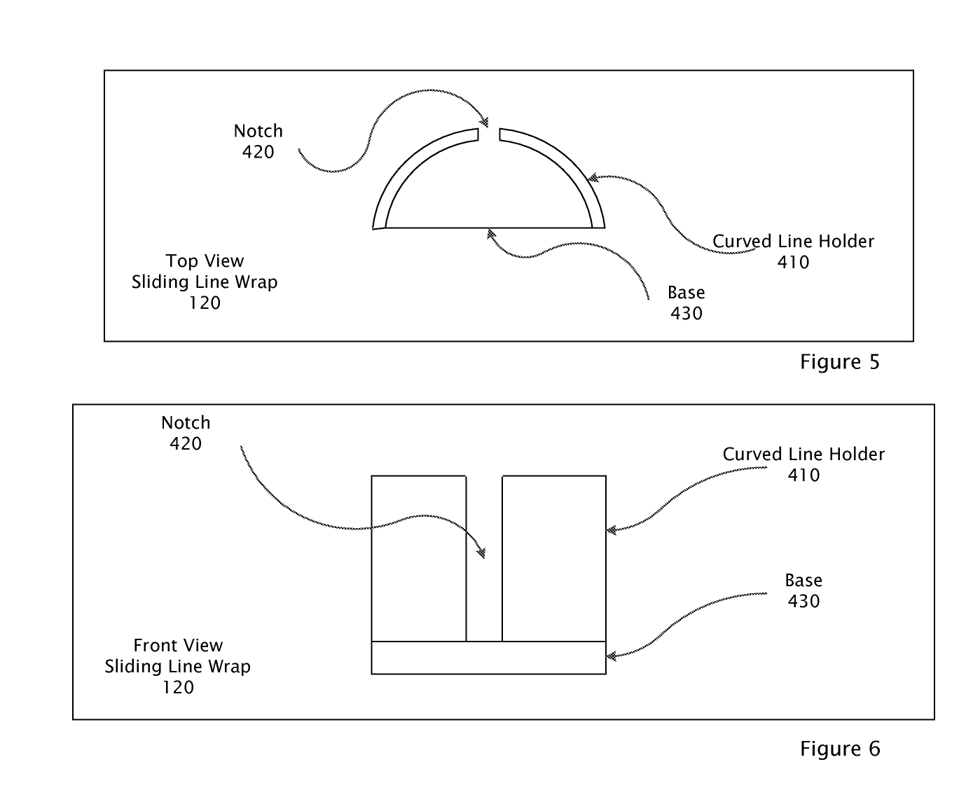

FIG. 5 is a top view of one embodiment Sliding Line Wrap 120. Curved Line Holder 410 may be made with a horizontal cylindrical segment. Notch 420 may allow passing a fishing line leader through the Curved Line Holder 410. In this embodiment Curved Line Holder 410 may be made from one block of material, including a base which may have a way to fit into Guide 130. For example, Base 430 may have a protruding block which would fit into Guide 130 and may prevent Sliding Line Wrap 120 from rotating, while allowing Sliding Line Wrap 120 to slide in Guide 130. In this embodiment, Guide 130 may have a series of ridges and Sliding Line Wrap 120 may have a spring activated latch to push a stopper into a ridge in Guide 130, locking Sliding Line Wrap 120 into position.

FIG. 6 is a front view of one embodiment of Sliding Line Wrap 120. One having skill in the art will recognize that various techniques may be used to allow Sliding Line Wrap 120 to slide in Guide 130, with a way of holding Sliding Line Wrap 120 in a plurality of positions within Guide 130.

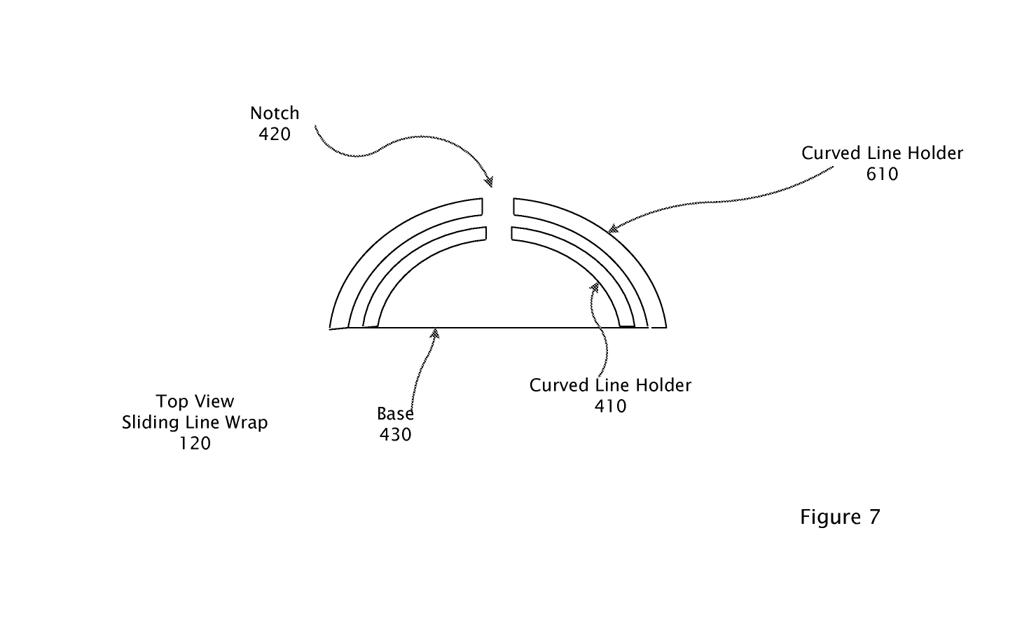

FIG. 7 is a top view of another embodiment of Sliding Line Wrap 120. In this embodiment, there may be a Curved Line Holder 610 in addition to Curved Line Holder 410. This may allow for additional paths for wrapping to accommodate fishing leader lines of various lengths. Curved Line Holder 610 may be made in the shape of a horizontal cylinder section of a greater radius than Curved Line Holder 410.

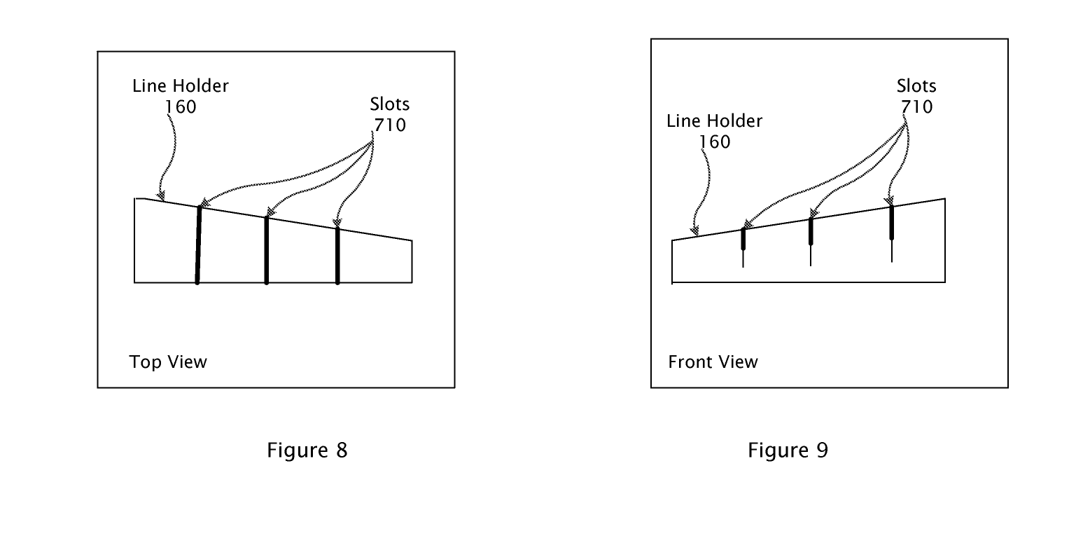

FIG. 8 is a top view of one embodiment of Block Line Holder 160. Loose End 330 of a fishing leader line may slide into Slots 710. Slots 710 may be made of a material with a suitable coefficient of friction with fishing line to hold Loose End 330 without slipping. For example, Slots 710 may be made with a rubberized material. Slots 710 may vary in width and depth to allow for different sizes of fishing line to be securely held. In this example, Block Line Holder 160 has 3 slots. In another embodiment, Line Holder 160 may have twelve or more slots of varying widths and depths.

FIG. 9 is a front view of one embodiment of Block Line Holder 160. In this embodiment, Slots 710 have a first width for part of their depth, and a second width for part of their depth. In another embodiment, Slots 710 may have one width their entire depth. In yet another embodiment, Slots 710 may have varying widths in a V-shape. One having skill in the art will recognize many designs for slots may allow holding fishing line.

In another embodiment, Block Line Holder 160 may be replaced by a steel coil spring, which may hold a Loose End 330 between two coils to hold a fishing line securely. One skilled in the art will recognize many different ways may be used to hold Loose End 330 securely.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A fishing leader line holder, comprising:
a backing panel;
a first sliding line wrap;
a first fixed line wrap;
a line tension release;
a block line holder; and
a hook holding device.

2. The fishing leader line holder of claim 1 further comprising a second sliding line wrap.

3. The fishing leader line holder of claim 1 further comprising a second fixed line wrap.

4. The fishing leader line holder of claim 1 wherein the line holder is a block having a first end and a second end, the second end wider than the first end, the second end shorter than the first end, and slots extending down from a top sufficient to hold fishing line.

5. The fishing leader line holder of claim 1 wherein the hook holding device is a peg.

6. The fishing leader line holder of claim 5 wherein the peg has an adjustable position.

7. The fishing leader line holder of claim 1 wherein the hook holding device is a bar.

8. The fishing leader line holder of claim 7 wherein the bar's position on the backing panel is adjustable.

9. The fishing leader line holder of claim 1 wherein the first sliding line wrap comprises:
a base;
a horizontal cylindrical segment;
a notch in the horizontal cylindrical segment; and
a means to couple the base to the backing panel;

10. A fishing leader line holder, comprising:
a backing panel having a length and a width;
a means for holding a loose end of a fishing leader line located within approximately one third of the length of the backing panel of a first end of the backing panel;
a peg movably coupled to the backing panel, configured to move along a portion of the length of the backing panel, the portion of the length located approximately ten percent to forty percent of the length or the backing panel from a second end, the second end being opposite the first end of the backing panel;
a spring coupled to the peg, configured to move the peg in the lengthwise direction away from the loose-end holding means.

11. The fishing line holder of claim 10, wherein the means for holding comprises a block line holder.

12. The fishing line holder of claim 10, wherein the means for holding comprises a spring.

13. The fishing line holder of claim 10, wherein the means for holding comprises a peg.
